(19) United States
(12) Patent Application Publication
(10) Pub. No.: US 2004/0113081 A1
(43) Pub. Date: Jun. 17, 2004

(54) Gas velocity measurement by infrared radiation absorption

(76) Inventor: John Hyde, Scawthorpe (GB)

Correspondence Address: MAINE & ASMUS, 100 MAIN STREET, P O BOX 3445, NASHUA, NH, 03061-3445, US

(21) Appl. No.: 10/472,832

(22) PCT Filed: Mar. 22, 2002
(86) PCT No.: PCT/GB02/01140

(30) Foreign Application Priority Data
Mar. 22, 2001 (GB) 0107184.4

(51) Int. Cl. G01N 21/59

(52) U.S. Cl. 250/345

(57) ABSTRACT

The velocity of a flowing gas is measured by detecting the pattern of infrared absorption of the gas stream at two locations (2,3) spaced apart in the direction of flow and measuring the time lapse between the sensing of the same radiation pattern by the first and second sensors. The velocity can be derived from the time lapse and the known distance between the sensors. In this way, the velocity of particulate-free gas flows can be measured.

### FIELD OF THE INVENTION

The invention is concerned with techniques, methods and apparatus for measuring the velocity of a flowing gas. The invention is particularly concerned with techniques that operate successfully with gases containing little or no particulate material.

Background to the Invention

A number of techniques have been developed for the measurement of velocity of flowing gases. Such technologies include turbines inserted in the gas stream, thermal probes measuring the cooling effect, and Pitot tubes, measuring the pressure exerted by the flowing gas and venturi restrictions creating a measurable pressure drop. All of these techniques require physical contact of a sensor or sensing device/assembly with the gas stream. This presents a significant problem when the gas stream is hot, corrosive or erosive.

To overcome reliability problems with these techniques a range of non-contact techniques have been developed such as Doppler, ultrasonic differential time of flight and time of flight. However, whilst they avoid the problems associated with contact-type sensors, problems with these measurement techniques still exist, be it on a financial or technical basis. Ultrasonic differential time of flight is becoming more common but is expensive whilst time of flight requires a specific characteristic present in the target gas that can be identified and tracked over a measured distance.

A number of methods have been developed along these lines. In gas streams that have no known visible events, such as suspended particles, the measurement is much more difficult. To overcome this problem a number of methods have been employed, such as the measurement of infra red radiation from a moving gas cloud as outlined in U.S. Pat. No. 3,558,898.

With this method, small temperature variations are measured as they pass through a known distance. The system uses the temperature of the gas stream and the associated radiance of gas at different temperatures. An assumption is made that the gas radiance will be different at different points of the gas stream and the movement of this difference can be tracked and timed. However this system suffers from problems of dissociation of the gas if the stations are too far apart and is clearly only of use for measuring the velocity of hot gases. Typically, the system involves a path length of between 600 mm to 1000 mm between stations. Other approaches, such as that disclosed in GBA-2349946, use particulates suspended in the gas stream. These methods all assume that particulates will not be homogeneously distributed and hence concentration differences can be identified and measured. This method does however depend on the presence of particulates. Briefly, the method involves observation of a pattern of particulates in the gas stream at two spaced apart stations. Analysis of particulate patterns is necessary on a continuous basis until the pattern registered at the second, down-steam station matches that registered at the first, upstream station. A simple mathematical expression is all that is needed to convert the time lapse between registration of the pattern at both stations to an indication of gas velocity.

The method is clearly subject to the pattern remaining substantially the same in its passage between the two stations. It becomes a virtual necessity, therefore, that the stations are close together in order to minimise the opportunity for mixing or dispersion of the particulates in the gas which would then destroy the pattern and thereby lead to a false result.

In applications such as gas turbine power generation and waste incineration, particulate levels are extremely low and insufficient particulates are present to provide a measurable pattern. However, the present invention aims to provide a method in which the infra red high accuracy of time of flight can be applied without the requirement of particulates or high gas temperatures to measure velocity.

In order to place the present invention in proper perspective and as an aid to understanding the significance of the invention to gas flow measurements, a brief survey of Time of Flight Velocity Measurement follows.

The principal of time of flight velocity measurement has been in common use for many years and as digital signal processing becomes more cost effective new applications are being identified. The technique is based on measuring the time it takes for a known event to move through a known distance. As the time and distance are then known the velocity can be calculated. Depending on the medium, the event can be a vehicle passing over pressure pads on the road or sub micron particles passing through laser beams. The general technique is well known. The problem of measuring time of flight lies in identifying a suitable and perhaps unique characteristic of the target and measuring its movement relative to time. This can be achieved by measuring solids suspended in the gas stream or hot spots in the gas stream. If neither is present the techniques fail.

In combustion processes, a change in the molecular makeup of the gas stream takes place. The combustion process generally takes ambient air, which is a homogeneous mix of oxygen, nitrogen, water and very low levels of other gases. This homogeneous mix is then mixed with the fuel. This fuel is generally a hydrocarbon-based fuel but could be carbon or hydrogen. As the fuel and air are mixed in the combustion zone, combustion of the fuel takes place in a turbulent manner.

As a consequence of this combustion process a number of products and by products are produced. In the case of a hydrocarbon-based fuel the main products are heat, water and carbon dioxide. A number of by-products are also generated as a consequence of imperfect combustion, the two major by-products being carbon monoxide and nitrogen dioxide. The carbon monoxide is generated by incomplete combustion of the fuel due to localised oxygen deficiencies whilst the nitrogen dioxide is generated by the combination of atmospheric nitrogen with atmospheric oxygen in localised hot spots where excess oxygen is present.

These reactions are in general not homogeneous due to many factors such as turbulence, fuel variation etc. In other words, they are generated by localised turbulence within the combustion zone. The effect of this process is to create localised pockets or clouds of these gases. The resulting gas stream comprises a range of products such as CO₂, CO, NO, N₂, O₂, H₂O along with others. The concentration of these gases will vary with time, even on a very short time scale of a few milliseconds.

All of the gas species above are invisible in their vapour states, hence the requirement for particulates. However, if the above are viewed in the infra red spectrum, they absorb infra red light by varying amounts according to the wavelength of light being considered, the type of gas present, the temperature and the pressure of the gas. An analogy to this is the process of generating clouds of different coloured gas with differing levels of translucence. As these clouds are of a non-homogeneous nature they can be tracked and timed. In real terms this must be implemented in the infra red spectrum where the gases of interest absorb light. This forms the basis of the present invention.

### SUMMARY OF THE INVENTION

According to the present invention, there is provided a method of measuring the velocity of a gas stream, the method comprising sensing the infra red radiation absorption pattern in a portion of the gas stream at two locations spaced a predetermined distance apart in the direction of gas flow, measuring the time lapse between sensing the same radiation pattern by the first and second sensors, and calculating the velocity from the said time lapse and said predetermined distance.

The invention also comprises apparatus for measuring the velocity of a gas stream, the apparatus comprising first and second sensors spaced a predetermined distance apart in the direction of gas flow, each sensor being adapted to detect the infra red radiation absorption pattern of the gas in the stream, means for measuring the time lapse between sensing the same radiation pattern by the first and second sensors, and means for calculating the gas velocity from the said time lapse and the said predetermined distance.

The sensors each preferably consist of an infra red radiation emitter and a corresponding infra red detector. The emitter is suitably a hot wire emitter. The infra red radiation emitter and the corresponding infra red radiation detector are preferably located on opposite sides of the gas stream so that the infra red radiation is transmitted substantially transversely across and through the gas stream.

Each emitter and/or each detector may include a reflector to focus the infra red radiation.

The means for measuring the time lapse preferably comprises cross-correlation means having an input from each sensor whereby to identify the points in time at which the same absorption pattern is detected in each sensor.

The sensors may use broad band infra red radiation so that all components of the gas stream that absorb radiation may be detected. The principal advantage of this option is that the signal will be generated by a variety of gases so it is immaterial whether the path length between detector stations is short or long since dissociation will not affect the sensor readings. In this case, the detectors preferably operate over a range between just below visible red to long wave infra red. This range is compatible with CO, CO₂, and water vapour absorption bands.

Alternatively, the sensors may use narrow band infra red radiation designed to target a specific gas or gas species within the gas stream. The specific gas may be carbon dioxide.

Tracking the specific point of the gas stream is preferably performed by measuring the absorption level on a continuous basis at said two locations.

A typical detector suitable for this application is a lead selenide detector having a spectral response of 2 μm to 4.5 cm, and a response time of 3 μs.

### BRIEF DESCRIPTION OF THE DRAWINGS

The preferred embodiments of the invention will be described with reference to the accompanying drawings, in which:

FIG. 1 is a schematic representation of the overall system;

FIG. 2 illustrates typical signals sensed by the detectors in FIG. 1;

FIG. 3 shows the result of cross-correlating the signals in FIG. 2; and

FIG. 4 is a schematic representation of the signal processing used in the system to evaluate the gas velocity.

### DETAILED DESCRIPTION OF THE ILLUSTRATED EMBODIMENTS

In brief outline, the two signals generated by the two sensors will be similar in shape but time shifted by the time it takes for the gas to travel between the two sensors. Digital signal processing is then used to perform a cross correlation function on the two waveforms. The peak of the result will then occur at the flight time of the gas between the two detection paths. As the central lines of the detection paths are known, the velocity can be calculated. The preferred manner in which this is done will now be described by reference to the drawings.

FIG. 1 shows a typical application in which the gas stream, shown generally at 1, is traversed by two separate infra red beams 2, 3 transmitted through the gas stream. The radiation emitted by first and second infra red sources 4, 5 is detected, after passage through the gas stream and after absorption by the gaseous components within the gas stream, by corresponding first and second infra red radiation detectors 6, 7. Reflectors 8 may be provided for each source and/or each detector but for small ducts these may not be necessary as there will be sufficient signal strength without reflectors.

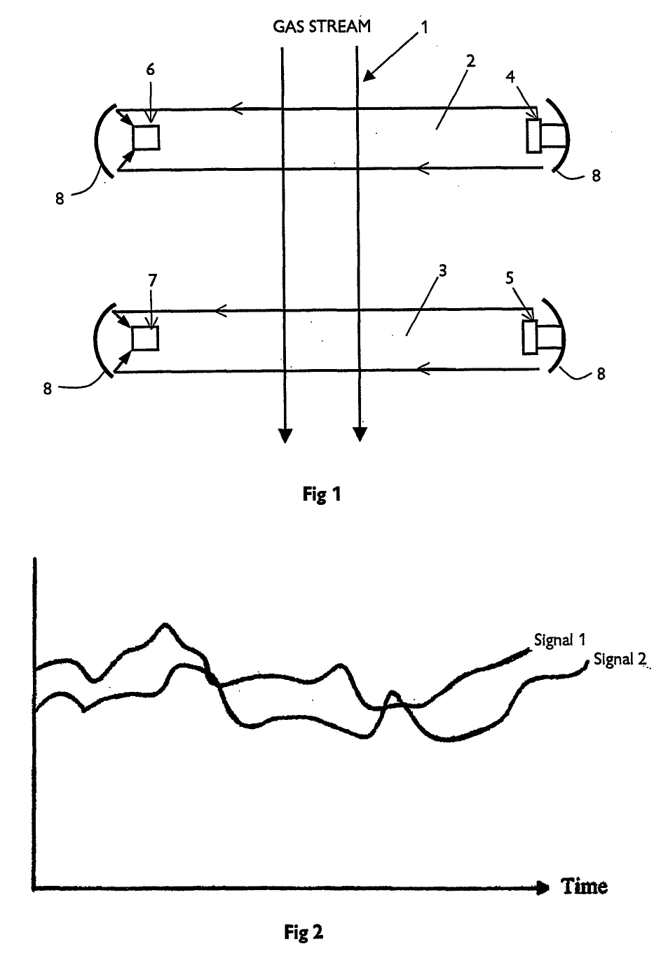

Each detector will generate an electrical signal proportional to the amount of infra red light received. As the concentration of different gases pass through the beam, a varying electrical signal will result. A typical output signal from each of the detectors is shown in FIG. 2 in which “Signal 1” is the signal from the upstream detector 6 and “Signal 2” is from the downstream detector 7.

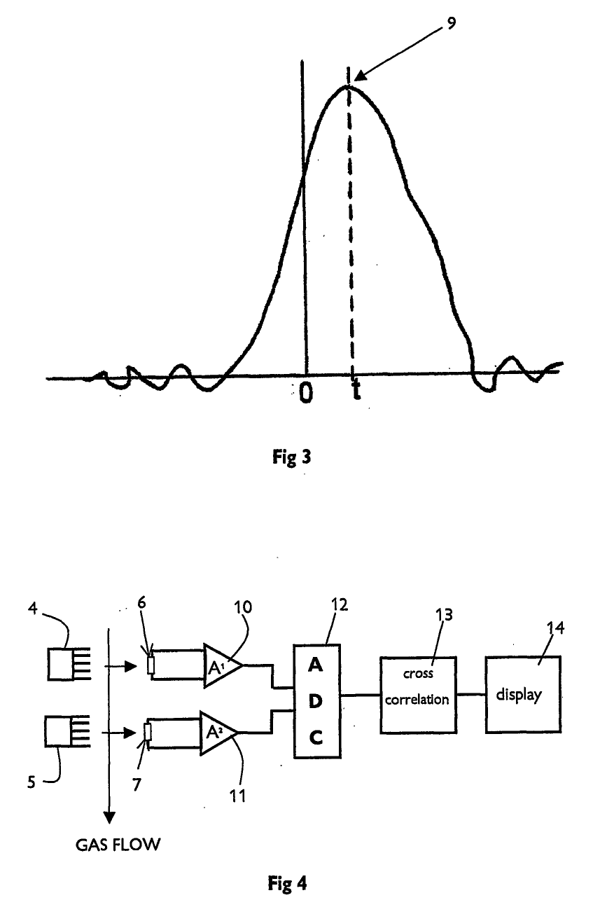

As can be seen, the two signals generated by the two sensors will be similar in shape but time shifted by the time it takes for the gas to travel between the two sensors. Digital signal processing is then used to perform a cross correlation function on the two waveforms. A typical waveform resulting from such cross-correlation is shown in FIG. 3. The peak 9 of the resulting waveform will occur at the flight time of the gas between the two detection paths. As the distance between the centre lines of the detection paths are known, the velocity can readily be calculated.

FIG. 4 illustrates a block diagram of the necessary processing circuitry to perform the cross-correlation. The output signals from the first and second infra red detectors 6, 7 are fed via respective amplifiers 10, 11 and converted to digital form in an analogue-to-digital converter 12. The digital output from the A/D converter passes to a digital cross-correlator 13 which performs the required cross-correlation function. The output of the cross-correlator 13 is shown as passing to a display 14 which may simply display the time of flight or may display the result of the additional calculation necessary to indicate the velocity of the gas stream.

As compared to prior gas velocity detectors, the present invention operates without the need for particulates in the gas stream. Moreover, the present method makes it possible to use miniaturised and sensitive detectors, with the result that the detectors (and sources) may be placed close together. This has the added advantage that there is less opportunity for dispersal of the gas in the stream as it passes from one detector to the other, thereby increasing accuracy and making a compact system. In contrast to know systems, the detectors may be placed as close as 50-75 mm apart.

Suitable sensors may consist of lead selenide detectors having a spectral response of 2 μm to 4.51 μm and a response time of 3 μs.

The system has particular application to measuring the velocity of gases involved in combustion processes. For example, it could be used to measure the velocity of flue gases which can be cold and are not amenable to prior art systems that rely on hot gases. By the same token, particulates may be effectively absent, following filtering.

The system may also be used to advantage to measure the velocity of air used to blow coal into a burner and/or to measure the velocity of that portion of the exhausted air which is recirculated to warm the incoming air, the temperature being too low for systems relying on hot gases.

The system of the invention works satisfactorily in all types of flow but is particularly effective where the gas stream is fairly uniform and there is substantially no turbulence which would otherwise result in pressure variations, leading to density variation and hence fluctuations in absorption.

1. A method of measuring the velocity of a gas stream, comprising sensing the infra red radiation absorption pattern in a portion of the gas stream at two locations spaced a predetermined distance apart in the direction of gas flow, measuring the time lapse between sensing the same radiation pattern by the first and second sensors and calculating the velocity from the said time lapse and said predetermined distance.

2. A method according to claim 1, comprising detecting a radiation absorption pattern at a first of the locations, performing a correlation between the detected pattern from the first location and the radiation absorption pattern detected at the second location downstream from the first, and determining the temporal separation of the correlated patterns.

3. A method according to claim 1 or 2, comprising providing at each location a broad band infra red source and a broad bank infra red detector spaced apart from each other transversely of the gas flow direction.

4. Apparatus for measuring the velocity of a gas stream, the apparatus comprising first and second sensors spaced a predetermined distance apart in the direction of gas flow, each sensor being adapted to detect the infra red absorption pattern of the gas in the steam, means for measuring the time lapse between sensing the same radiation pattern by the first and second sensors, and means for calculating the gas velocity from the said time lapse and the said predetermined distance.

5. Apparatus according to claim 4, wherein each sensor comprises an infra red radiation emitter and a corresponding infra red radiation detector spread apart from each other transversely of the gas flow direction.

6. Apparatus according to claim 5, wherein the emitter and detector are located on opposite sides of the gas stream.

7. Apparatus according to claim 5 or 6, wherein each emitter includes a reflector to focus the infra red radiation.

8. Apparatus according to claim 5, 6 or 7, wherein the or each detector includes a reflector to focus the infra red radiation.

9. Apparatus according to any of claims 5 to 8, wherein the means for measuring the time lapse comprises cross-correlation means having an input from each sensor whereby to identify the points in time at which the same absorption pattern is detected in each sensor.

10. Apparatus according to any of claims 5 to 10, wherein the sensors use broad band infra red radiation, whereby all components of the gas stream that absorb radiation may be detected.

11. Apparatus according to claim 10, wherein the sensors operate over a wavelength range of from first below visible red to long wave infra red.

12. Apparatus according to any of claims 5 to 10, wherein the sensors use narrow band infra red radiation.

13. Apparatus according to any of claims 5-2, arranged to monitor infra red absorption continuously at the two locations.
